(19) United States
(12) Patent Application Publication
(10) Pub. No.: US 2015/0334216 A1
(43) Pub. Date: Nov. 19, 2015

(54) SYSTEM AND METHOD FOR SENDING MESSAGES

(71) Applicant: HAMAN INTERNATIONAL INDUSTRIES ,INC., Stamford, CT (US)

(72) Inventor: Jianjun MA, Shanghai (CN)

(73) Assignee: HARMAN INTERNATIONAL INDUSTRIES, INC, Stamford, CT (US)

(21) Appl. No.: 14/652,451

(22) PCT Filed: Dec. 23, 2013
(86) PCT No.: PCT/CN2013/090200

§ 371 Date: Jun. 15, 2015

(30) Foreign Application Priority Data
Dec. 31, 2012 (CN) 201210593936.0

(51) Int. Cl. H04M 1/60; H04M 1/725; H04W 4/04; H04W 4/14

(52) U.S. Cl. CPC H04M 1/6075; H04W 4/14; H04M 1/72552; H04W 4/046

(57) ABSTRACT

Method and system for sending messages are provided. The method may include: a head unit mounted on a vehicle providing a plurality of options each of which represents obtaining a corresponding piece of information; the head unit receiving a user instruction of selecting at least one of the plurality of options; the head unit obtaining at least one piece of information corresponding to the selected at least one option according to the user instruction; the head unit composing a first message using the obtained at least one piece of information; and the head unit sending to a first mobile device the first message and a request for forwarding the first message. Drivers can send a message safely and conveniently when driving.

### CROSS-REFERENCE TO RELATED APPLICATIONS

The present application claims priority to Chinese patent application No. 201210593936.0, filed on Dec. 31, 2012, and entitled “METHOD FOR RESPONDING MOBILE PHONE SMS MESSAGE USING VEHICLE-MOUNTED HEAD UNIT”, and the entire disclosure of which is incorporated herein by reference.

### TECHNICAL FIELD

The present disclosure generally relates to sending messages.

### BACKGROUND

It is dangerous for a user to send messages by operating a mobile device, such as a smart phone, or the like when driving. There is need for safe and convenient solutions of sending messages by drivers.

### SUMMARY

According to one embodiment, a method for responding a message is provided. The method may include: a first communication system receiving a first message from a second communication system; the first communication system providing a plurality of options each of which represents obtaining a corresponding piece of information; the first communication system receiving a user instruction of selecting at least one of the plurality of options; the first communication system obtaining at least one piece of information corresponding to the selected at least one option according to the user instruction; the first communication system composing a second message using the obtained at least one piece of information; and the first communication system sending the second message to the second communication system.

In some embodiments, the first communication system may be a mobile phone.

In some embodiments, the first communication system may be a vehicle mounted head unit.

In some embodiments, the first communication system may include a vehicle mounted head unit and a mobile phone. In some embodiments, a data connection may be established between the head unit and the mobile phone through wireless connection, such as through Bluetooth, Wi-Fi, etc. In some embodiments, the data connection may be established between the head unit and the mobile phone through wired connection, such as through USB, IEEE 1394, etc.

In some embodiments, the first and second messages may be short messaging service (SMS) messages.

In some embodiments, the plurality of options may include an option for obtaining a current position of the first communication system.

In some embodiments, the plurality of options may include an option for obtaining estimation of when the first communication system will arrive at a predefined destination.

In some embodiments, the plurality of options may include an option for obtaining estimation of how long it will take the first communication system to arrive at a predefined destination.

In some embodiments, the first communication system may obtain the at least one piece of information from itself, a vehicle mounted component, or a server.

In some embodiments, the first communication system may present the plurality of options on a screen, and the user instruction may be input by pressing at least one button which is actuatable to instruct the first communication system to obtain a piece of information corresponding to each of the plurality of options.

In some embodiments, the first communication system may provide on a touch screen a plurality of tags each of which represents one of the plurality of options and is actuatable to instruct the first communication system to obtain a corresponding piece of information.

According to one embodiment, a method for sending a message is provided. The method may include: a head unit mounted on a vehicle providing a plurality of options each of which represents obtaining a corresponding piece of information; the head unit receiving a user instruction of selecting at least one of the plurality of options; the head unit obtaining at least one piece of information corresponding to the selected at least one option according to the user instruction; the head unit composing a first message using the obtained at least one piece of information; and the head unit sending to a first mobile device the first message and a request for forwarding the first message.

In some embodiments, the first mobile device may be a mobile phone, a tablet personal computer, a personal digital assist, or the like. In some embodiments, the head unit provides the plurality of options in response to the first mobile device receiving a second message from a second mobile device, and the request for forwarding the first message is a request for forwarding the first message to the second mobile device.

In some embodiments, the head unit may establish data connection with the first mobile device. In some embodiments, the data connection may be wireless connection, such as by Bluetooth, Wi-Fi, or the like. In some embodiments, the data connection may be wired connection, such as by USB, IEEE 1394, etc.

In some embodiments, the first message may be a short messaging service (SMS) message.

In some embodiments, the plurality of options may include an option for obtaining a current position of the head unit.

In some embodiments, the plurality of options may include an option for obtaining estimation of when the head unit will arrive at a predefined destination.

In some embodiments, the plurality of options may include an option for obtaining estimation of how long it will take the head unit to arrive at a predefined destination.

In some embodiments, the head unit may obtain the at least one piece of information from itself, another component mounted on the vehicle, or a server.

In some embodiments, the head unit may present the plurality of options on a screen, and the user instruction may be input by pressing at least one button which is actuatable to instruct the head unit to obtain a piece of information corresponding to each of the plurality of options. In some embodiments, the at least one button may be mounted on a steering wheel of the vehicle.

In some embodiments, the head unit may provide on a touch screen a plurality of tags each of which represents one of the plurality of options and is actuatable to instruct the head unit to obtain a corresponding piece of information.

According to one embodiment, a system for sending a message is provided. The system may include a communication device, a display and a processing device. The processing device may be configured to: control the display to present a plurality of options each of which represents obtaining a corresponding piece of information; in response to a user instruction of selecting at least one of the plurality of options, obtain at least one piece of information corresponding to the selected at least one option; compose a first message using the obtained at least one piece of information; and control the communication device to send the first message to a communication system.

In some embodiments, the system may be a mobile phone.

In some embodiments, the system may be a vehicle mounted head unit.

In some embodiments, the system may include a vehicle mounted head unit and a mobile phone, where the head unit provides the display and the processing device, and the mobile phone provides the communication device. In some embodiments, a data connection may be established between the head unit and the mobile phone through wireless connection, such as through Bluetooth, Wi-Fi, etc. In some embodiments, the data connection may be established between the head unit and the mobile phone through wired connection, such as through USB, IEEE 1394, etc.

In some embodiments, the first message may be a short messaging service (SMS) message.

In some embodiments, the plurality of options may include an option for obtaining a current position of the system.

In some embodiments, the plurality of options may include an option for obtaining estimation of when the system will arrive at a predefined destination.

In some embodiments, the plurality of options may include an option for obtaining estimation of how long it will take the system to arrive at a predefined destination.

In some embodiments, the processing device may be configured to control the display to present tags each of which represents one of the plurality of options. In some embodiments, the user instruction may be input by operating be at least one button which is actuatable to instruct the system to obtain at least one piece of information. In some embodiments, the system may be a head unit mounted on a vehicle, and the at least one button may be mounted on a steering wheel of the vehicle.

In some embodiments, the display may be a touch screen, where the touch screen may, under control of the processing device, present tags each of which represents one of the plurality of options and is actuatable to instruct the system to obtain a corresponding piece of information.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 schematically illustrates a flow chart of a method for responding a message according to one embodiment;

FIG. 2 illustrates a schematic block diagram of a system for responding a message according to one embodiment;

FIG. 3 schematically illustrates a first interface according to one embodiment; and

FIG. 4 schematically illustrates a second interface according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

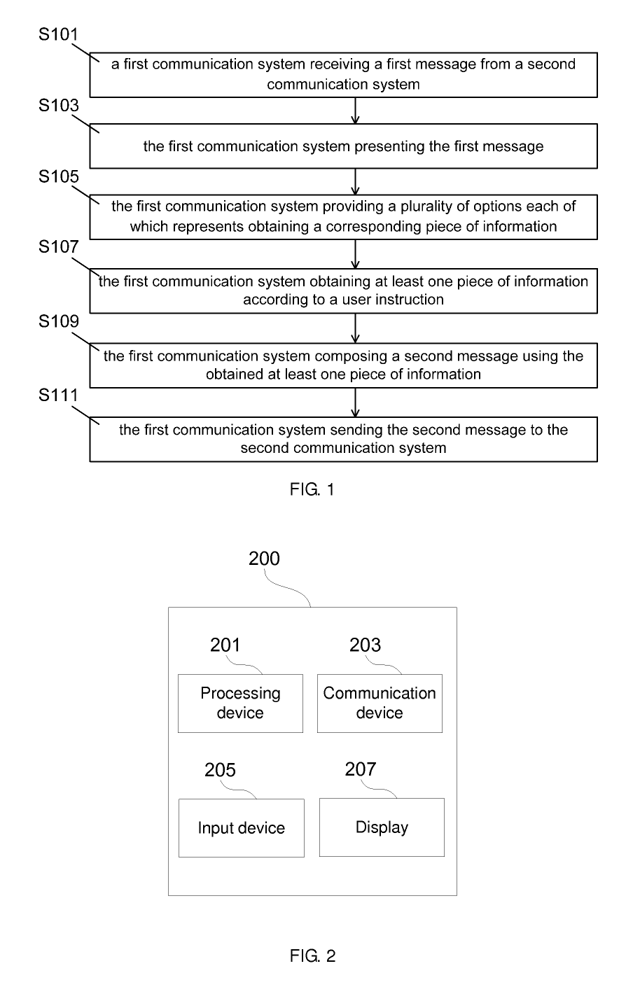

FIG. 1 schematically illustrates a flow chart of a method 100 for responding a message.

In S101, a first communication system receiving a first message from a second communication system.

FIG. 2 illustrates a schematic block diagram of a first communication system 200 according to one embodiment. In some embodiments, the first communication system 200 may include a processing device 201, a communication device 203, an input device 205 and a display 207.

In some embodiments, the first communication system 200 may be a mobile device carried by a user, such as a mobile phone, a tablet computer, or the like. The mobile device may receive the first message from the second communication device through a mobile network. For example, a mobile phone may receive a short messaging service (SMS) message through a cellular network, or a tablet computer may receive a piece of web information from a website server through a 3G network.

In some embodiments, the first communication system 200 may be a vehicle mounted head unit. Some vehicle may be equipped with a head unit with mobile communication components, such as a 3G module. Therefore, the vehicle mounted head unit may receive the first message from the second communication system.

In some embodiments, the first communication system 200 may include a vehicle mounted head unit and a mobile device, where the vehicle mounted head unit may provide the processing device 201, the input device 205 and the display 207, and the mobile device may function as the communication 203. Therefore, information can be presented to the user using the head unit, and instructions can be input by operating the head unit. Besides, even if the head unit does not have a communication device for receiving and sending a message through a mobile network, the method 100 can still be implemented with assistance of the mobile device, such as a mobile phone. In some embodiments, a data connection may be established between the head unit and the mobile phone through wireless connection, such as through Bluetooth, Wi-Fi, etc. In some embodiments, the data connection may be established between the head unit and the mobile phone through wired connection, such as through USB, IEEE 1394, etc. Such that, when the mobile device receives the first message, it can send the first message to the head unit. The head unit may implement several processing to form a message for responding the first message and send the formed message to the mobile device, such that the mobile device can forward the formed message to the second communication system.

Hereinafter, embodiments of implementing the method 100 using a communication system including a vehicle mounted head unit and a mobile phone will be illustrated in detail. Other embodiments of implementing the method 100 using a mobile device or a head unit can be conceived in light of the descriptions below.

In some embodiments, the first message may include event information and sender information, and the first communication system may obtain both the event information and the sender information. For example, the first message may be a short message. Once the mobile phone receives the short message, it may transmit contents of the short message and sender identification number of the short message to the head unit. The sender identification number may be a phone number. In some embodiments, if the sender identification number is related to a contact name in the mobile phone, the mobile phone may further transmit the contact name to the head unit.

In S103, the first communication system presenting the first message.

The head unit may present the first message in a visible way or an audio way. For example, the processing device 201 of the head unit may control the display 107 to show the first message, or control an audio system mounted on the vehicle to broadcast the first message.

In some embodiments, the head unit may give a reminder indicating that the first message is received. If the user chooses to learn about the first message and input a corresponding instruction, the head unit may present the first message, or else, the head unit won't present the first message. In some embodiments, the reminder may include the sender information, such that the user can determine whether to learn about the event information or not based on the sender information.

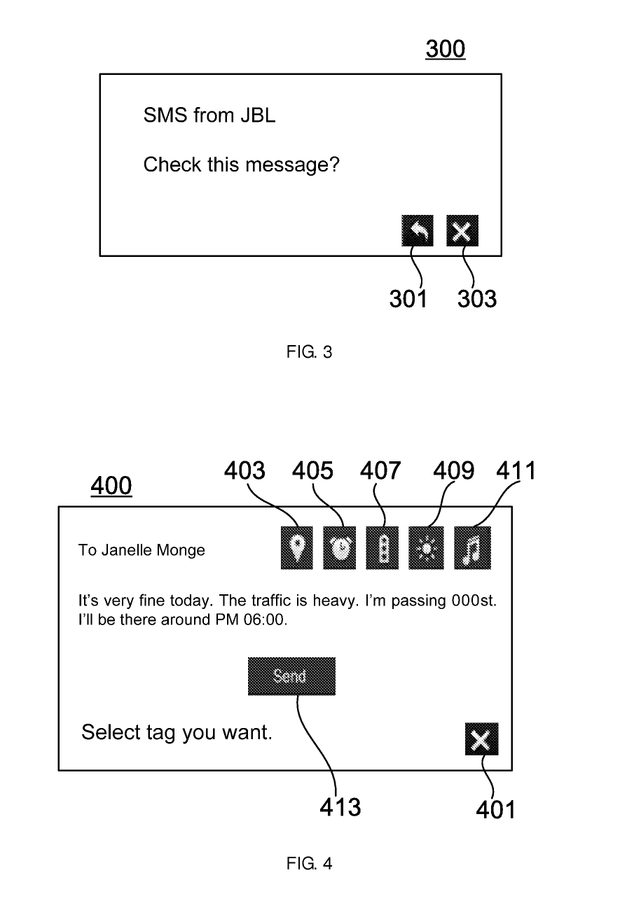

FIG. 3 schematically an example of an interface 300 of the head unit. The interface 300 may be shown on the display 207. The interface 300 may illustrate a reminder of the first message, which shows the sender information of the first message. The interface 300 may further provide several options to deal with the reminder. For example, if the user wants to know the contents of the first message, he/she may click a tag 301 to input an instruction to play event information, or else, he/she may click an tag 303 to input an instruction to cancel the reminder.

User instruction(s) may be input through the input device 205 by the user to instruct the head unit to conduct certain operation(s). In some embodiments, the input device 205 may include at least one button. The tag 301 or the tag 303 may be clicked, i.e., corresponding user instruction may be input, by actuating the at least one button. In some embodiments, the input device 205 and the display 207 may be integrated in a touch screen. The touch screen may present the first message and some tags, and corresponding instructions may be input by pressing the tags.

In S105, the first communication system providing a plurality of options each of which represents obtaining a corresponding piece of information.

To respond the first message, some information may be used. The head unit may provide a plurality of options, such that the user can select what kind of information to be sent for responding the first message.

In some embodiments, the processing device 201 may control the display 207 to present the plurality of options. In some embodiments, the display 207 may show a plurality tags each of which represents one of the plurality of options, such that the user can know what kind of information can be used to respond the first message. By inputting a corresponding user instruction through the input device 205, the user can select at least one piece of information to be sent. In some embodiments, the user instruction may be input by actuating at least one button, or clicking one or more tags shown on the display 207 if it's a touch screen. In some embodiments, the at least one button may be mounted on a steering wheel of the vehicle, such that the user can operate the at least one button conveniently.

FIG. 4 schematically illustrates an interface 400. The interface 400 may be presented on a touch screen. The interface 400 may provide a plurality of tags 401, 403, 405, 407, 409, 411 and 413. The tags 403, 405, 407, 409 and 411 may represent the plurality of options. The tag 403 may represent an option for obtaining a current position of the head unit, i.e., the current position of the vehicle. The tag 405 may represent an option for obtaining an estimation of arrival time. The tag 407 may represent an option for obtaining traffic condition. The tag 409 may represent an option for obtaining weather condition. And the tag 411 may represent an option for obtaining information of the music the user is listening to.

User instructions may be input by pressing one or more tags of the interface 400. Specifically, if the user presses the tag 411, a user instruction of cancelling message responding may be input. If the user presses any one of the tags 403, 405, 407, 409 and 411, a user instruction of obtaining a piece of information corresponding to an option represented by the selected tag may be input. The user may press more than one tag of the tags 403, 405, 407, 409 and 411, such that a user instruction of obtaining more than one corresponding piece information may be input. The processing device 201 may receive the user instruction(s) and conduct certain processing accordingly.

In S107, the first communication system obtaining at least one piece of information according to a user instruction.

In some embodiments, the head unit may obtain a current position of itself, i.e., current position of the vehicle according to the user instruction. The current position may be obtained from a vehicle-mounted navigation device, such as a global position system. In some embodiments, the position information may include a name of the location such as the name of a street, a building etc. It may be obtained based on GPS signal and a digital map.

In some embodiments, the head unit may obtain an estimation of arrival time, i.e., an estimation of when the head unit will arrive at a predefined destination. In some embodiments, the arrival time may be a time point of arriving the predefined destination or a time period from now to the time point of arriving the destination. The estimation of arrival time may be obtained from the vehicle-mounted navigation device or a server.

In some embodiments, the head unit may further obtain traffic information, weather information or information of music played in the vehicle from a server and/or a vehicle-mounted component.

In S109, the first communication system composing a second message using the obtained at least one piece of information.

The processing device 201 may add obtained information into a predefined message pattern to form the second message. In some embodiments, the head unit may present the second message, so the user can know the contents of the second message and decide whether or not to send the second message. Referring still to FIG. 4, the interface 400 further provides an example of the second message. It could be seen that the second message shown on the interface 400 includes current position, estimation of arrival time, traffic information and weather information, which are obtained according to user instructions input by pressing the tags 403, 405, 407 and 409. A user instruction of sending the second message may be input by pressing the tag 413.

In S111, the first communication system sending the second message to the second communication system.

The head unit may send the second message to the mobile phone, such that the mobile phone can forward the second message to the second communication system. In some embodiments, the mobile phone may forward the second message to the sender of the first message, i.e., the second communication system. In some embodiments, the head unit may determine at least one address according to a user instruction or a predefined scheme, and transmit the determined address to the mobile phone together with the second message, such that the mobile phone can forward the second message to the determined address.

It should be noted that, the disclosure may not be limited to responding a SMS message. In some embodiments, sending a message initiatively may be implemented. Specifically, an address list may be pre-stored in the head unit. The display 207 may present the address list, such that the user can select an address from the list through the input device 205. A message formed by the head unit may be sent to the mobile phone together with the selected address, and the mobile phone may forward the message to the address.

There is little distinction left between hardware and software implementations of aspects of systems; the use of hardware or software is generally a design choice representing cost vs. efficiency tradeoffs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for responding to a message, comprising:
receiving a first message from a second communication system;
in response, providing a plurality of options to a user, wherein each option is related to obtaining a corresponding piece of information;
receiving a user instruction to select at least one option included in the plurality of options;
obtaining at least one piece of information corresponding to the at least one option;
generating a second message based on at least one piece of information; and
transmitting the second message to the second communication system.

2. The method according to claim 1, wherein the first and second messages are short messaging service (SMS) messages.

3. The method according to claim 1, wherein the plurality of options includes an option for obtaining a current position of the first communication system.

4. The method according to claim 1, wherein the plurality of options includes an option for obtaining an estimation of when the first communication system should arrive at a predefined destination.

5. The method according to claim 1, wherein the user instruction is received as an input to a screen via at least one button that is actuatable to instruct a first communication system to obtain the at least one piece of information corresponding to the at least one option.

6. The method according to claim 1, wherein the screen comprises a touch screen that presents a plurality of tags representing different information types, and the user instruction is received via a first tag that is actuatable to instruct a first communication system to obtain the at least one piece of information corresponding to the at least one option.

7. A system for sending a message, comprising:
a head unit mounted on a vehicle and configured to:
provide a plurality of options to a user, wherein each option is related to obtaining a corresponding piece of information;
receive a user instruction to select at least one option included in the plurality of options;
obtain at least one piece of information corresponding to the at least one option;
generate a first message based on the at least one piece of information; and
transmit to a first mobile device the first message and a request for forwarding the first message.

8. The system according to claim 7, wherein the first message is a short messaging service (SMS) message.

9. The system according to claim 7, wherein the plurality of options includes an option for obtaining a current position of the head unit.

10. The system according to claim 7, wherein the plurality of options includes an option for obtaining an estimation of when the first communication system should arrive at a predefined destination.

11. The system according to claim 7, wherein the head unit is configured to present the plurality of options on a screen, and the user instruction is input by pressing at least one button which is actuatable to instruct the head unit to obtain the at least one piece of information corresponding to the at least one option.

12. The system according to claim 7, wherein the head unit includes a touch screen on which a plurality of tags representing different information types is presented, and the user instruction is received via a first tag that is actuatable to instruct the head unit to obtain the at least one piece of information corresponding to the at least one option.

13. A system for sending a message, comprising:
a communication device;
a display; and
a processing device, wherein the processing device is configured to:
control the display to present a plurality of options to a user, wherein each option is related to obtaining a corresponding piece of information;
in response to a user instruction to select at least one option included in the plurality of options, obtain at least one piece of information corresponding to the at least one option;
generate a first message based on the at least one piece of information; and
control the communication device to transmit the first message to a communication system.

14. The system according to claim 13, wherein the plurality of options includes an option for obtaining a current position of the system.

15. The system according to claim 13, wherein the plurality of options includes an option for obtaining an estimation of when the first communication system should arrive at a predefined destination.

16. The system according to claim 13, wherein the processing device is configured to control the display to present a plurality of tags, wherein each tag represents a different one of the plurality of options and can be selected by operating at least one button.

17. The system according to claim 13, wherein the display comprises a touch screen that is configured ty the which, under, under control of the processing device to present a plurality of tags, wherein each tag represents a different one of the plurality of options and is actuatable to cause the processing device to obtain a corresponding piece of information.
